(19) United States
(12) Patent Application Publication
(10) Pub. No.: US 2025/0157103 A1
(43) Pub. Date: May 15, 2025

(54) MEDIA STREAM STORYBOARD GENERATION

(71) Applicant: Microsoft Technology Licensing, LLC, Redmond, WA (US)

(72) Inventors: Kori Marie INKPEN, Redmond, WA (US); Nicolai MARQUARDT, Sammamish, WA (US); John C. TANG, Palo Alto, CA (US); Asta Jane ROSEWAY, Friday Harbor, WA (US); Erzhen HU, Charlottesville, VA (US); Sasa JUNUZOVIC, Kirkland, WA (US); Nathalie M. RICHE, Issaquah, WA (US)

(73) Assignee: Microsoft Technology Licensing, LLC, Redmond, WA (US)

(21) Appl. No.: 18/389,537

(22) Filed: Nov. 14, 2023

(51) Int. Cl. G06T 11/60; G06F 40/134; G06F 40/166

(52) U.S. Cl. CPC G06T 11/60; G06F 40/134; G06F 40/166

(57) ABSTRACT

A method for generating storyboards is described. An extraction prompt is provided to a first generative neural network model. The extraction prompt is a text-based prompt that instructs the first generative neural network model how to identify timestamps of segments having related content within transcripts according to dialog within the transcripts. A transcript of a meeting is provided as an input to the first generative neural network model. Segment timestamps for identified segments within the meeting are received from the first generative neural network model based on the extraction prompt and the transcript. Segment images for the identified segments are generated using a second generative neural network model, wherein each of the segment images represents segment content within a corresponding identified segment.

### BACKGROUND

Many conference calls take place among different teams within a large organization. Content within a conference call may be recorded by an individual participant (or a software application) so that key points that were discussed, or files that were presented, may be referred back to at a later time or viewed by a person who was unable to attend the conference call. In some cases, audio content may be transcribed by a speech processor or other suitable computing device. However, a transcript of a long conference call may be cumbersome for an individual to find relevant information. Additionally, a participant tasked with recording and memorializing the key points may be too busy to be an active participant in the conference call.

It is with respect to these and other general considerations that various aspects have been described. Also, although relatively specific problems have been discussed, it should be understood that the aspects should not be limited to solving the specific problems identified in the background.

### SUMMARY

Aspects of the present disclosure are directed to generating a storyboard that represents content within a media stream.

In one aspect, a method for generating storyboards is provided. An extraction prompt is provided to a first generative neural network model. The extraction prompt is a text-based prompt that instructs the first generative neural network model how to identify timestamps of segments having related content within transcripts according to dialog within the transcripts. A transcript of a meeting is provided as an input to the first generative neural network model. Segment timestamps for identified segments within the meeting are received from the first generative neural network model based on the extraction prompt and the transcript. Segment images for the identified segments are generated using a second generative neural network model, wherein each of the segment images represents segment content within a corresponding identified segment.

In another aspect, a system for generating story boards is provided. The system comprises at least one processor, and at least one memory storing computer-executable instructions that when executed by the at least one processor cause the at least one processor to: provide an extraction prompt to a first generative neural network model, wherein the extraction prompt is a text-based prompt that instructs the first generative neural network model how to identify timestamps of segments having related content within transcripts according to dialog within the transcripts: provide a transcript of a meeting as an input to the first generative neural network model: receive, from the first generative neural network model, segment timestamps for identified segments within the meeting based on the extraction prompt and the transcript: generate segment images for the identified segments using a second generative neural network model, wherein each of the segment images represents segment content within a corresponding identified segment.

In yet another aspect, a method for generating a story board is provided. One or more segments within a media stream are identified according to content within the one or more segments, including providing an extraction prompt and a transcript of the media stream to a large language model, wherein the content comprises dialog from at least one user and the extraction prompt is a text-based prompt that instructs the large language model how to identify the one or more segments. Segment labels are generated for the one or more segments according to the content within the one or more segments using the large language model. Segment images are generated, for the one or more segments, for a story board of the media stream, wherein each of the segment images represents segment content within a corresponding segment and sources of the segment content.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows an example block diagram of a media stream processing system, according to an aspect.

FIG. 2 shows an example diagram of a transcript and a corresponding story board, according to an aspect.

FIG. 3 shows an example block diagram for a media stream processor, according to an aspect.

FIG. 4 shows another example block diagram for a media stream processor, according to an aspect.

FIG. 5 shows an example prompt and response for a neural network model, according to an aspect.

FIG. 6 shows yet another example block diagram for a media stream processor, according to an aspect.

FIG. 7 shows a diagram of an example method for generating story boards, according to an aspect.

FIG. 8 shows a diagram of another example method for generating story boards, according to an aspect.

FIG. 9 is a block diagram illustrating example physical components of a computing device with which aspects of the disclosure may be practiced.

FIG. 10 is a simplified block diagram of a computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Meetings, presentations, conference calls, video calls, webinars, and other types of meetings may be recorded as a media stream, such as a video, MP3, streaming video file, streaming audio file, etc. For a relatively short duration meeting of only five minutes, finding key points within the media stream may be challenging and time consuming for a user that did not take part in the meeting. For longer meetings of an hour or more, even participants of the meeting may have difficulty locating key points for summarizing the meeting, refreshing their memory of the meeting, etc.

In some aspects, to improve access to useful information about a meeting, a story board is generated based on the media stream. Although a story board is typically used in the film industry to sketch out a story before producing a film, the story board in the present disclosure is used to summarize a meeting that has already occurred. The story board provides a visual summary of content within the meeting, such as discussion points, shared files, contributions from various participants, etc. The story board may have several images that each represent a logical segment within the meeting. For example, a first segment may represent a discussion of a recent financial report, a second segment may represent a discussion of future actions to take based on the financial report, and so on. The images may include a representation of participants who contributed to the corresponding segment, for example, as captured images from a media stream (e.g., from the user's webcam) or as computer generated avatars. The images may also include dialog bubbles with words spoken by the contributing participants. Accordingly, the story board may have an appearance similar to a comic strip that may be quickly read by a user that wishes to understand the content of the meeting and its contributors.

In one aspect, a media stream processor identifies segments within a media stream according to content within the segments. The content may include dialog from users or participants of a meeting where the meeting has been recorded to the media stream. The media stream processor generates segment labels for the segments according to the content within the segments. For example, after identifying the different segments, the media stream processor provides a caption for an image that would represent the segment. The media stream processor also generates segment images for the segments for a story board of the media stream. Each of the segment images represents segment content within the corresponding segment and sources of the segment content (e.g., participants that provided dialog).

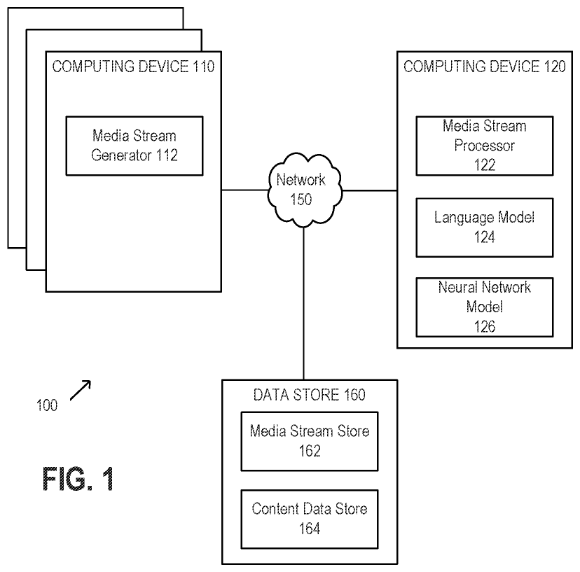

In accordance with embodiments of the present disclosure, FIG. 1 depicts an example block diagram of a media stream processing system 100. In the example shown in FIG. 1, the media stream processing system 100 includes one or more computing devices 110, a computing device 120, and a data store 160. Generally, the computing device 110 generates a suitable media stream for a meeting, for example, by generating a recording of a video conference. The computing device 120 is configured to generate images for the media stream, where the images represent content within the media stream. Generally, the images may be used to summarize the meeting by including images representative of contributing participants, dialog from the participants, or other content from the meeting, as described below. The data store 160 is configured to store media streams for meetings (e.g., generated by the computing device 110), documents and files that may be shared during meetings, or other suitable files. A network 150 communicatively couples the computing device 110, the computing device 120, and the data store 160. The network 150 may comprise one or more networks such as local area networks (LANs), wide area networks (WANs), enterprise networks, the Internet, etc., and may include one or more of wired, wireless, and/or optical portions.

For ease of description, the examples described herein generally refer to a meeting as a video conference among two or more participants that is recorded to a media stream. However, other types of a meeting may be used in other aspects, embodiments, and/or scenarios. For example, the meeting may be in-person, a presentation, conference call (e.g., audio only), video call (e.g., audio and video), webinar, or other suitable type of meeting. In some examples, a single video camera may be used to record a presentation given in front of a live audience. In other examples, a plurality of participants of a meeting are located in two or more locations (e.g., personal office, home office, conference room, etc.), each location with their own audio and/or video recording device. In some examples, the meeting is simply a recording of one or more scenes, such as a performance of a play, a classroom presentation or lesson, etc. Other types of meetings or scenes that may benefit from having a story board generated will be apparent to those skilled in the art.

As a meeting takes place, the meeting may be recorded by the computing device 110 to a media stream. The computing device 110 may be any suitable type of computing device, including a desktop computer, PC (personal computer), smartphone, tablet, or other computing device that may be used by a participant of the meeting. In other examples, the computing device 110 may be a video recorder, action camera, webcam, voice recorder, or other suitable recording device. In other examples, the computing device 110 may be a server, distributed computing platform, or cloud platform device that receives data from suitable computing or recording devices. The computing device 110 may be configured to execute one or more software applications (or “applications”) and/or services and/or manage hardware resources (e.g., processors, memory, etc.), which may be utilized by users of the computing device 110.

The computing device 110 comprises a media stream generator 112 configured to generate the media stream. The media stream generator 112 may be implemented as a software program (e.g., running on a processor of the computing device 110), such as Microsoft Teams, Zoom, Meet, or another suitable video or audio conferencing program, that generates a suitable media stream for a meeting (such as a video file, MP4 file, MP3 audio file, etc.). In other examples, the media stream generator 112 is implemented as a dedicated video encoder, audio encoder, or multimedia encoder. Generally, the media stream may be any suitable file format, streaming format, etc. for storing or streaming a meeting. In some examples, the media stream generator 112 combines multimedia streams from other sources into a single media stream, for example, by combining video streams from different participants of a meeting into a single media stream.

After a meeting has been recorded into a media stream, the computing device 120 may generate suitable images for the media stream, as described herein. The computing device 120 may be any suitable type of computing device, including a desktop computer, PC (personal computer), smartphone, tablet, or other computing device. In other examples, the computing device 120 may be a server, distributed computing platform, or cloud platform device. The computing device 120 may be configured to execute one or more software applications (or “applications”) and/or services and/or manage hardware resources (e.g., processors, memory, etc.), which may be utilized by users of the computing device 120.

Content presented during a meeting is recorded to the media stream. Examples of content within the media stream may include dialog (e.g., spoken by the participants) or other suitable audio, images that were recorded, documents that were shared, etc. Images that were recorded may include images from a webcam, images from a whiteboard (e.g., from an electronic whiteboard or an image of a dry erase whiteboard used by a participant), avatar images for the participants (e.g., for participants with their webcam turned off), etc.

The computing device 120 comprises a media stream processor 122 that generates images for a story board of a media stream. In some examples, the computing device 120 further comprises a language model 124 and a neural network model 126. As described above, the story board may provide a visual summary of content within a meeting, such as discussion points, shared files, contributions from various participants, etc. The story board may have several images that each represent a logical segment within the meeting. The media stream processor 122 may be configured to identify segments within a media stream according to content within the segments. As an example, a media stream may have a duration of ten minutes and twenty seconds (10:20) and the media stream processor 122 may identify a first segment with a duration from 00:00 to 02:10, a second segment from 02:10 to 8:33, and a third segment from 8:33 to 10:20. Generally, the media stream processor 122 identifies the segments so that each segment corresponds to similar content (e.g., sharing a same discussion topic), as described herein. The media stream processor 122 generates segment labels for the segments, such as a text label or image label for a topic discussed during the segment, and also generates segment images. The segment images represent segment content within the corresponding segment and sources of the segment content, as described herein.

Generally, the language model 124 is a neural network model configured for generating a text output based on a text input. The output is generally in a natural language format, for example, written in a conversational way that is readily understood by users even without special training on computers. The neural network model 126 is a model configured for other processing tasks, such as image generation or extraction from a media stream, segmentation of a media stream, segment label generation, transcript generation from a media stream, or other suitable processing. Although only one instance of the neural network model 126 is shown for clarity, the computing device 120 may comprise two, three, or more instances of the neural network model 126 to provide various processing tasks, described herein. Although the language model 124 and neural network model 126 are shown as part of the computing device 120, the language model 124 and/or the neural network model 126 may be implemented on the computing device 110, the data store 160, a standalone computing device (not shown), a distributed computing device (e.g., cloud service), or other suitable processor.

For image generation or extraction, the neural network model 126 (or an instance thereof) may be implemented as a diffusion model (e.g., Stable Diffusion), generative adversarial network (e.g., StyleGAN), neural style transfer model, large language model modified for image generation (e.g., DALL-E, Midjourney), or other suitable generative neural network model. In some examples, a first instance of the neural network model is used to generate one or more images (e.g., representing users) and a second neural network model is used to augment the generated images from the first neural network model, for example, by converting the images to have a desired aesthetic style, to include dialog bubbles, to arrange the generated images into a desired template, etc.

The media stream generator 112 and the media stream processor 122 may be implemented as software modules, application specific integrated circuits (ASICs), firmware modules, or other suitable implementations, in various embodiments. The data stores 162 and 164 may be implemented as one or more of any type of storage mechanism, including a magnetic disc (e.g., in a hard disk drive), an optical disc (e.g., in an optical disk drive), a magnetic tape (e.g., in a tape drive), a memory device such as a random access memory (RAM) device, a read-only memory (ROM) device, etc., and/or any other suitable type of storage medium.

The data store 160 is configured to store media streams generated by the media stream generator 112 and other content related to meetings. Generally, the data store 160 comprises a media stream store 162 that stores the media streams and a content data store 164 that stores the content. Examples of the content may include documents, presentations, images, etc. In various embodiments, the data store 160 is a network server, cloud server, network attached storage (“NAS”) device, or other suitable computing device. The data store 160 may include one or more of any type of storage mechanism, including a magnetic disc (e.g., in a hard disk drive), an optical disc (e.g., in an optical disk drive), a magnetic tape (e.g., in a tape drive), a memory device such as a random access memory (RAM) device, a read-only memory (ROM) device, etc., and/or any other suitable type of storage medium. Although only one instance of the data store 160 is shown in FIG. 1, the media stream processing system 100 may include two, three, or more similar instances of the data store 160. Moreover, the network 150 may provide access to other data stores, similar to data store 160 that are located outside of the media stream processing system 100, in some embodiments.

Although a single instance of the media stream store 162 and the content data store 164 are shown, the media stream store 162 and the content data store 164 may be implemented in a distributed manner across several instances of the data store 160. For example, a first data store may host an Exchange server for email and user accounts, a second data store may host a SharePoint server for files, documents, and media streams, a third data store may host a SQL database, etc.

As described above, the language model 124 is a neural network model, such as a large language model (LLM), and may be configured to process prompts and inputs and provide a text-based output. The language model 124 may be implemented as a transformer model (e.g., Generative Pretrained Transformer), for example, or other suitable model. Generally, the language model 124 may receive a prompt from a user, application programming interface (API), an application executed by a computing device (e.g., computing device 110 or computing device 120) other suitable input source.

Generally, the language model 124 is configured to process prompts or inputs that have been written in natural language or suitable text data format, but may also process prompts containing programming language code, scripting language code, text (formatted or plain text), pseudo-code, XML, HTML, JSON, images, videos, etc. In some scenarios, the text data format is compatible with an API for a software module or processor from which the language model 124 may receive input data, and/or with a software module or processor to which the language model 124 may provide output data.

In some examples, the language model 124 communicates with another neural network model (e.g., neural network model 126), executable (not shown), or API (not shown) that converts all or a portion of a received prompt or other input into a suitable format for processing by the language model 124. For example, the language model 124 may receive a prompt containing an image and a natural language question pertaining to the image. The language model 124 may provide the image to a neural network model that converts the image into a textual description of the content of the image, where the language model 124 then processes the textual description (either as an augmented prompt containing the textual description and natural language question, or as a follow-up prompt containing the textural description).

In other examples, an extraction prompt for the language model 124 comprises syntax examples for the language model 124 to extract segments, labels, etc. from a transcript of a media stream. Using the extraction prompt as a reference, the language model 124 is able to generate a suitable text output with a syntax as described in the extraction prompt. Generally, the extraction prompt describes a structure of the transcript (e.g., timestamps, participant, dialog, etc.) and semantics for how an output should be formatted. The extraction prompt may be a single prompt, or a plurality of separate prompts that are provided to the language model 124 (e.g., during a session startup, LLM initialization, after a reset, etc.). In still other examples, a prioritization prompt comprises syntax examples for the language model 124 to identify segments based on a prioritized user, such as a CEO, department head, meeting coordinator, etc.

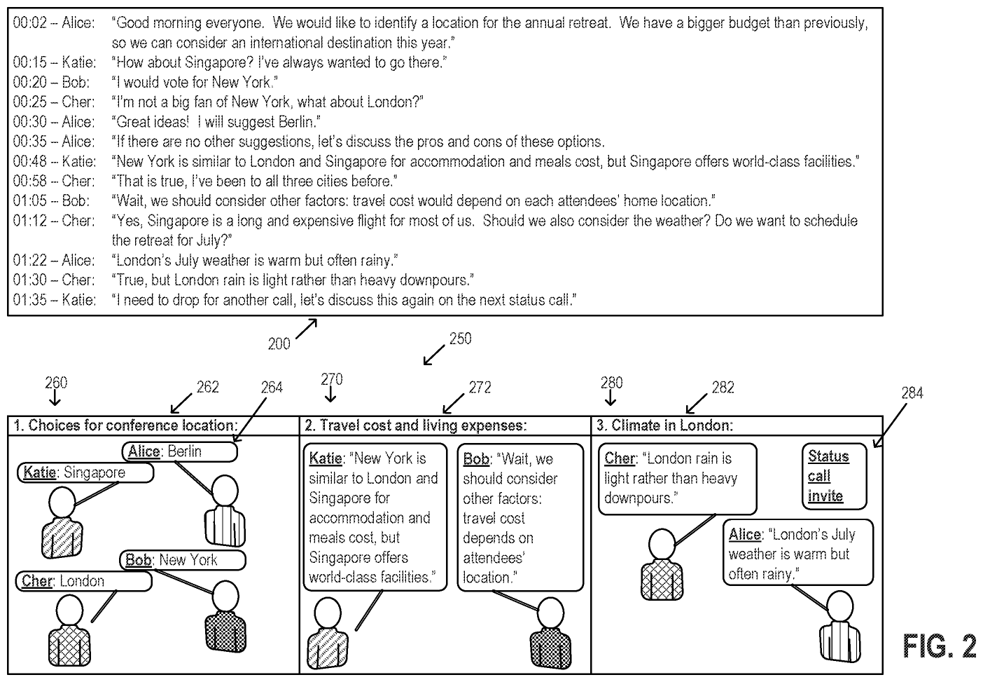

FIG. 2 shows an example diagram of a transcript 200 and a corresponding story board 250, according to an embodiment. Generally, the transcript 200 identifies a participant in a meeting who is speaking, words that were spoken by the participant, and a timestamp at which the words were spoken. The transcript 200 includes timestamps of start times for a sentence (or sentence fragment), a name or other identifier of a participant who spoke the sentence, and the content of the sentence. Although only a single time is shown for the timestamp, the timestamp may include a start and end time, in other examples. Moreover, additional metadata may be included in the transcript 200, such as identifiers for when a file was shared or shown on screen, links to the file shared, identifiers for audible noises or sounds (e.g., “[shuffling sounds]”, “[door slamming shut]”, [“upbeat music”]).

In the example shown in FIG. 2, the transcript 200 corresponds to a media stream with a length of approximately one minute and 35 seconds. To summarize the content of the media stream, the media stream processor 122 identifies three segments within the media stream, generates segment labels for the segments, and generates segment images 260, 270, and 280 for the segments. The media stream processor 122 may generate the segment images to include the corresponding segment label, such as the segment labels 262, 272, and 282.

The transcript 200 includes dialog content during a meeting among users Alice, Bob, Cher, and Katie as they discuss a location for an annual retreat. As an example, the media stream processor 122 may identify a first segment from 00:00 to 00:30 and generate a segment label of “Choices for conference location”, a second segment from 00:30 to 01:22 with segment label “Travel cost and living expenses”, and a third segment from 01:12 to 01:35 with segment label “Climate in London”. In this example, the second segment and the third segment overlap because Cher's comment beginning at 01:12 includes dialog from two different subjects, specifically, the travel cost and weather. In other examples, the media stream processor 122 may be configured to sub-divide a line to provide non-overlapping segments. For example, the media stream processor 122 may end the second segment and begin the third segment at 1:16.

Within each segment, the media stream processor 122 identifies participants who have contributed to the meeting during that segment. In the example shown in FIG. 2, each of Alice, Bob, Cher, and Katie contributed by providing at least a city name and the media stream processor 122 generates the segment image 260 for the first segment to include an avatar for each user, along with dialog provided by the corresponding user. The dialog may be displayed within a dialog bubble, such as dialog bubble 264, in a separate text box, or other suitable manner.

In the segment image 260, to improve readability, only a portion of dialog is displayed from each user. Specifically, instead of displaying “I would vote for New York.”, the dialog for Bob is shortened to just “New York”. In some examples, the portion of dialog displayed is a representation or summary of the actual dialog. For example, the media stream processor 122 may display “London rain is light rather than heavy downpours”, omitting the “True, but” of Cher's comment at 1:30. In still other examples, a longer dialog from a user may be paraphrased or otherwise suitably shortened to improve readability, fit within space constraints of the segment image, etc.

Although not shown in FIG. 2, in some examples, the media stream processor 122 is configured to group two or more users into a single avatar. For example, two different users who are both members of a software development team may have their dialog combined, and optionally shortened or paraphrased, and shown with a single avatar with a name of “Dev Team.” In this way, fewer avatars may be displayed within a segment image, providing more room for dialog.

In FIG. 2, the participants in the meeting are shown using avatars. In other examples, the media stream processor 122 extracts an image of a user from the media stream and uses the extracted image instead of the avatar. In some examples, the media stream processor 122 provides further processing of the extracted image, such as cartoonization, filtering, or other suitable visual effects.

In some examples, the media stream processor 122 generates a segment image to include a link to content shared, modified, created, etc. during the media stream, or related content that was not directly presented within the media stream, such as relevant documents, emails, meeting invites, etc. In the example shown in FIG. 2, the segment image 280 is generated to include a link 284 to a status call meeting, which was mentioned by Katie in the transcript 200 (01:35—“let's discuss this again on the next status call.”). The media stream processor 122 may be configured to retrieve the related content from electronic calendars associated with the participants, email clients, file servers, etc. In other examples, a link (e.g., similar to the link 284) to a document, presentation, Internet address, or other relevant file that was shared, modified, created during the media stream may be generated within the story board 250.

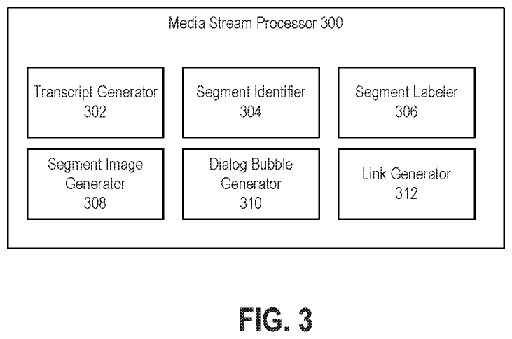

FIG. 3 shows an example block diagram for a media stream processor 300, according to an aspect. The media stream processor 300 generally corresponds to the media stream processor 122 and may be used to generate the segment images 260, 270, and 280 of FIG. 2, for example. The media stream processor 300 comprises a transcript generator 302, a segment identifier 304, a segment labeler 306, a segment image generator 308, a dialog bubble generator 310, and a link generator 312. Although these components are shown separately in the example of FIG. 3, two or more of the components may be combined or divided in other examples. For example, the segment identifier 304 and the segment labeler 306 may be combined as a single element, in some examples.

The transcript generator 302 is configured to receive a media stream and generate a corresponding transcript, such as the transcript 200. In some examples, the segment identifier 304 is implemented as a module within a software program (e.g., Microsoft Teams, Zoom, Meet, or another suitable video or audio conferencing program), or as a speech to text module or processor. In other examples, the segment identifier 304 is implemented at least in part as a neural network model, such as an instance of the neural network model 126. In some examples, the media stream includes the transcript and the transcript generator 302 may be omitted from the media stream processor 300.

The segment identifier 304 is configured to identify logical segments within a meeting according to content within the segments, for example, based on the transcript of the meeting. In some aspects, the segment identifier 304 may identify the segments to highlight a general mood of a scene or segment (e.g., laughter, agreement), active participants in the segment, disagreement among participants, shared documents, objects that are held up to a webcam and discussed, changes in lighting or audio levels, spatial movements of participants, or other content. On the other hand, the segment identifier 304 may also identify segments to avoid or omit trivial or unnecessary small talk, excessive conflict, or undesirable dialog from the story board.

As described above, the segment identifier 304 may process the transcript 200 and identify the first, second, and third segments. In some examples, the segment identifier 304 is implemented as a large language model, such as OpenAI Generative Pre-trained Transformer (GPT), Big Science Large Open-science Open-access Multilingual Language Model (BLOOM), Large Language Model Meta AI (LlaMA) 2, Google Pathways Language Model (PaLM) 2, or another suitable language model. In one such example, the segment identifier 304 corresponds to the language model 124. In other examples, the segment identifier 304 is implemented as a software module, application programming interface (API), or other software component that interfaces with the language model 124. In one such example, the segment identifier 304 is configured to provide one or more prompts to the language model 124 along with the transcript of the media stream.

In some examples, the segment identifier 304 is configured to prioritize one or more participants within a meeting. For example, a department head or CEO may be prioritized so that their dialog is more likely to be featured in a story board or segment image. In some examples, different story boards or segment images may be created to highlight particular users, with reduced emphasis on a timeline of the meeting. For example, a first segment (or multiple segments) may be prioritized around a CEO, with dialog taken from throughout the meeting, while a second segment (or multiple segments) may be prioritized around a department head, even when the first and second segments overlap in time. In such scenarios, the segment identifier 304 may identify a plurality of starting timestamps and ending timestamps for a single segment, i.e., a non-linear or non-contiguous segment. Alternatively, the segment identifier 304 may identify different segments, but flag the segments for creation of a single, combined segment image by the segment image generator, described below:

The segment labeler 306 is configured to generate a segment label for the segments identified by the segment identifier 304. For example, the segment labeler 306 may generate the segment labels 262, 272, and 282 based on the transcript 200 and the identified first, second, and third segments. Similarly, to the segment identifier 304, the segment labeler 306 may be implemented as a large language model, such as chatGPT or another suitable language model. In one such example, the segment labeler 306 corresponds to the language model 124. In other examples, the segment labeler 306 is implemented as a software module, application programming interface (API), or other software component that interfaces with the language model 124. In one such example, the segment labeler 306 is configured to provide one or more prompts to the language model 124 along with the transcript of the media stream. In some examples, the segment identifier 304 and the segment labeler 306 are implemented as a single component that receives the transcript 200 and provides a combined output that includes both the identification of the segments and the corresponding segment labels.

As described above, a storyboard may include images that provide a visual representation of content of the media stream. The segment image generator 308 is configured to generate suitable images, such as the segment images 260, 270, and 280. Generally, the images include a representation of participants who contributed to the corresponding segment. In various examples, representations of different participants may be captured images from a media stream (e.g., from a participant's webcam), a processor generated avatar or image, an avatar selected or uploaded by the participant, an avatar or image retrieved from an external source (e.g., a network account management server, a social media website, a profile server, or other suitable source), a logo, representative text, or other suitable visual representation. Note that for a meeting or media stream with audio only (i.e., a conference call), the segment image generator 308 may retrieve or generate the visual representation based on content within the transcript (e.g., names or phone numbers of participants that were spoken), data from an external source (e.g., phone numbers that were used to dial in), or images from an external source (profile images from a profile server). In some examples, the segment image generator 308 generates the image or an image portion for the participant. In other examples, the segment image generator 308 communicates with a language model (e.g., language model 124), a neural network model (e.g., neural network model 126), executable (not shown), or API (not shown) that generates the image or the image portion, or identifies frames within the media stream that contain suitable image portions.

The images may also include representations of content within the segment, such as images that were recorded, documents that were shared, etc. In some examples, the images may be generated to depict or represent what a scene from the meeting actually looked like, using extracted images, content from the transcript (descriptions or words), etc. In other examples, the images may be generated to depict or represent what a scene from the meeting may have looked like, for example, for an audio only conference call or a scene that was not captured on video (e.g., events occurring off camera or at a location without a camera). When video is not available, the segment image generator 308 may generate the images based on avatars of the participants, content from the transcript (descriptions or words), or other suitable data. Images that were recorded may include images from a webcam, images from a whiteboard (e.g., from an electronic whiteboard, or an image of a dry erase whiteboard used by a participant that is captured by a webcam), avatar images for the participants (e.g., for participants with their webcam turned off), etc. In one example, the segment image generator 308 determines user names for participants to be depicted in the image and retrieves corresponding images from a network administration server.

In the example shown in FIG. 2, the segment image 260 includes four representations of participants, while the segment image 270 includes only two representations of participants. Generally, the segment image generator 308 may be configured to select a subset of participants or content to be depicted in an image. The selection may be based on the transcript 200, or based on an identification of a participant, content, or frame within the media stream from the segment labeler 306 (e.g., from the language model 124). Moreover, the subset may be based on available space within the image to conform to desired minimum sizes for the image. For example, the segment image generator 308 generates the segment image 260 to include four avatars because only a relatively short length of dialog is included, while the segment image generator 308 generates the segment image 270 to include only two avatars (omitting Cher's relevant dialog) because the corresponding length of dialog is longer and additional avatars and dialog may not be readable. In some examples, where many participants are active during a segment, the segment image generator 308 may include an icon or number that indicates an actual number of participants (e.g., 10 participants, 20 participants) or a high volume of activity (e.g., an icon of a fire).

The segment image generator 308 may use one or more templates for generation of the segment images. For example, a four panel template may be used to generate the segment image 260, where the template includes upper left, upper right, lower left, and lower right panels that may be populated with avatars or image portions. As another example, a three panel template may be used to generate the segment image 280, where the template includes a left panel, an upper right panel, and a lower right panel. The templates may also specify font styles, colors, background images, label locations (e.g., to be populated by segment labeler 306), dialog bubble locations (e.g., to be populated by dialog bubble generator 310), links or links locations (e.g., to be populated by link generator 312), etc. Other variations of templates will be apparent to those skilled in the art.

In addition to static segment images, the segment image generator 308 may be configured to generate animated segment images, animated image portions, or other processed images. For example, the segment image generator 308 may extract a plurality of frames from the media stream to generate an animated image (e.g., graphics interchange format image, scalable vector graphics image). The plurality of frames may be a subset of actual frames so as to provide an increase in speed/time lapse or smaller file size. As another example, the segment image generator 308 may generate an animated avatar for a participant based on dialog from the participant, for example, so that the avatar's mouth appears to match the dialog. Animations may be generated to highlight facial expressions of a participant, actions taken by the participant, etc. As another example, a processed image may be generated that provides a heat map of usage area for a whiteboard displayed during a meeting.

In some examples, the segment image generator 308 is configured to use a facial recognition algorithm (e.g., an instance of the neural network model 126) to extract a suitable image from the media stream. In one example, the segment image generator 308 extracts an image when the facial recognition algorithm indicates that the participant is smiling, laughing, frowning, or making another expression that represents the content of the corresponding segment. The segment image generator 308 may use a timestamp, a segment duration, or other suitable identifier to reduce a search space needed to locate and extract the image. In some examples, the timestamps correspond to dialog spoken by the participant or indicate a response to the participant's dialog (e.g., [laughter] in the transcript located after the participant's dialog).

The dialog bubble generator 310 is configured to generate dialog bubbles, such as dialog bubble 264, for the segment images generated by the segment image generator 308. In some examples, the dialog bubble generator 310 is implemented as a software module, application programming interface (API), or other software component that interfaces with the language model 124. In some examples, the dialog bubble generator 310 populates existing dialog bubbles within a segment image according to a template, for example, by augmenting an image with text from the transcript. The dialog bubble generator 310 may receive input (e.g., dialog text and user names) from the language model 124 to populate the dialog bubbles and pixel coordinates for the dialog bubbles from the segment image generator 308, for example.

The link generator 312 is configured to generate links to the media stream where the links correspond to one or more of the segment images, the segment labels, the dialog bubbles, or the user avatars. For example, the link generator 312 may generate a link to a location within the media stream such that activation of the link begins play back of the media stream at the beginning of a corresponding line. The link generator 312 may also be configured to generate links to documents or files that were shared, emails, meeting invites (e.g., meeting invite link 284), etc. In some examples, the link generator 312 is implemented as a software module, application programming interface (API), or other software component that interfaces with the language model 124, for example, to identify and/or obtain suitable links to be inserted into the segment images.

In scenarios where a group of two or more users are represented by a single avatar, the link generator 312 may be configured to generate a link to a nested segment image or nested story board. For example, a user may click on a link within a dialog bubble for a group of users where the dialog bubble includes a paraphrasing of dialog from the group of users. In response to clicking the link, a segment image or story board may be displayed that provides more detail about the paraphrased dialog, for example, providing separate avatars for the users and corresponding dialog bubbles.

As described above, the segment image generator 308 may use templates for generation of the segment images. Moreover, the media stream processor 300 may use story board templates for combining segment images into a storyboard, or for providing parameters to one or more of the segment identifier 304, the segment labeler 306, the segment image generator 308, the dialog bubble generator 310, and the link generator 312. In some examples, the story board templates may have an appearance similar to a comic strip that may be quickly read by a user that wishes to understand the content of the meeting and its contributors. In other examples, the story board templates may have an executive summary style having an abstract or summary, followed by a bulleted list of key points made by the participants. Other types of story board templates will be apparent to those skilled in the art.

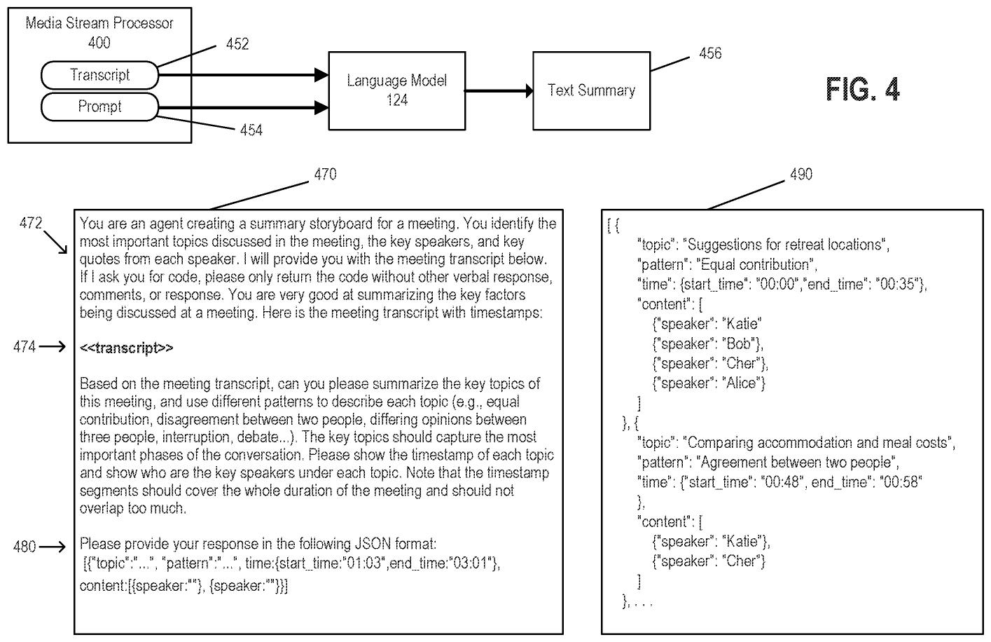

FIG. 4 shows another example block diagram of a media stream processor 400 of FIG. 3, according to an aspect. The media stream processor 400 may generally correspond to the media stream processor 300, for example, and generate a transcript 452, for example, using the transcript generator 302 as described above. The media stream processor 400 provides the transcript 452 and a prompt 454 to the language model 124, which outputs a suitable text summary 456. In various examples, the text summary 456 comprises a plurality of parameters for the segment labeler 306, the segment image generator 308, the dialog bubble generator 310, and the link generator 312. An example text summary that may correspond to the segment image 280 is provided below:
[SegmentIdentifier: “3”;
SegmentLabel: “Climate in London:”:
SegmentTemplate: Participants_2_Links_1:
Participant1Avatar: “Cher.jpg”:
Participant1Dialog: “Cher: ‘London rain is light rather than heavy downpours.”
Participant2Avatar: “Extract (01:22)”;
Participant2Dialog: “Alice: ‘London's July weather is warm but often rainy”.
Link1Label: “Status call invite”;
Link1Link: “MeetingIndex(0021654)”;
SegmentBackground: None]

In some examples, the extraction prompts described above are based on the example text summary above and the transcript 200. Other examples of extraction prompts will be apparent to those skilled in the art. FIG. 4 also shows an example prompt 470 and response 490. The prompt 470 is an example of an extraction prompt that may be provided to the language model 124 (or the neural network model 126), which is configured to implement all or a portion of the segment identifier 304, the segment labeler 306, the segment image generator 308, the dialog bubble generator 310, and the link generator 312. Although the prompt 470 is shown as a single prompt, it may be divided into multiple prompts, in other examples.

The prompt 470 includes instructions 472 written in natural language or other suitable text data format. The instructions 472 ask for an initial segmentation (“You identify the most important topics . . . ”) along with timestamps (“Please show the timestamp of each topic . . . ”), a pattern description (“patterns to describe each topic . . . ”), and identification of key speakers (“show who are the key speakers under each topic . . . ”).

The prompt 470 also includes a transcript 474 (shown as “<<transcript>>” for ease of explanation), such as the transcript 200. In other examples, the transcript 474 may be provided as a link to a transcript (e.g., in a network file location, web server, etc.) that the language model 124 or neural network model 126 uses to retrieve the text of the transcript.

The prompt 470 also includes a sample output structure 480 to be followed by the language model 124 or neural network model 126 when providing an output based on the transcript 474. In the example shown in FIG. 4, the sample output structure 480 defines a topic for a segment, a pattern for the segment (e.g., a template for formatting a segment image), start and end times for the segment, and content that was provided from relevant speakers for the segment. An example of the text summary 456 is shown as a response 490, based on the prompt 470 and the transcript 200.

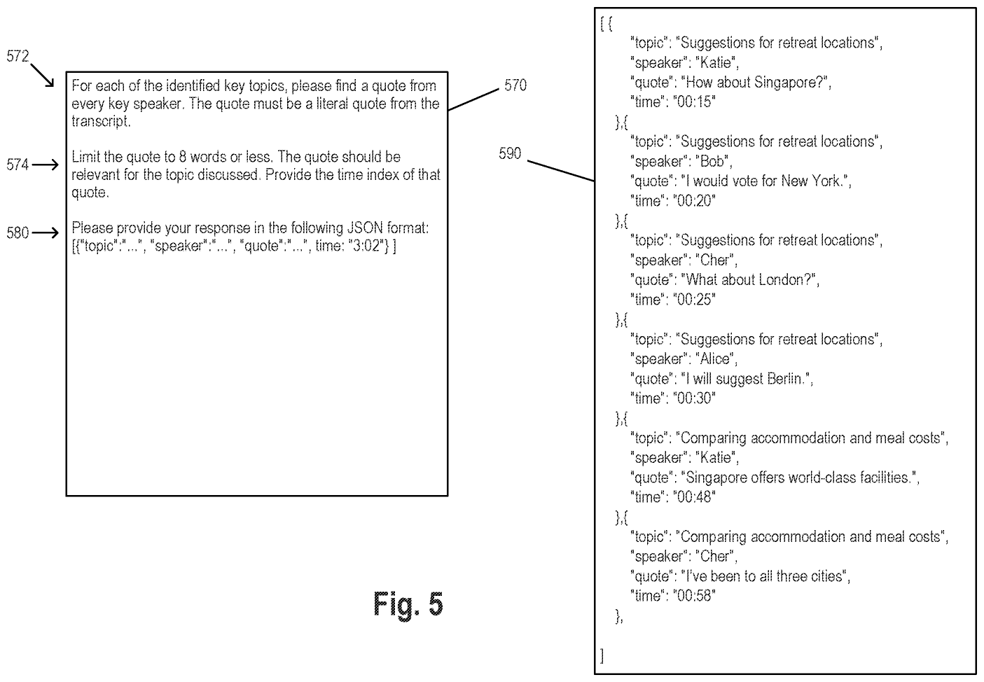

FIG. 5 shows an example prompt 570 and response 590 for a neural network model, such as the language model 124 or the neural network model 126. The prompt 570 includes instructions 572, written in natural language or other suitable text data format, configured to instruct the language model 124 or the neural network model 126 to extract key quotes from a suitable transcript. The instructions 572 may include a size limit 574 for the response 590 itself, or for quotes within the response 590. In the example shown in FIG. 5, the size limit 574 provides a limit of eight words for each quote from a user. In some examples, a different size limit 574 is used according to characteristics of the content within the segment. For example, a segment having only two active users may use a higher limit of 12 words, while a segment having four or more active users may use a lower limit of four to eight words. In other examples, the size limit 574 may be based on other characteristics of a segment image, such as whether full-body avatars (taking up more space within an image) are used or only icons or headshots (leaving more room for quotes).

In the example shown in FIG. 5, the prompt 570 is provided to the language model 124, after the prompt 470, which provides the response 590. As shown in FIG. 5, the response 590 includes a topic for a segment, a speaker's name, a quote from the speaker pertaining to the topic, and a timestamp for the quote. The prompt 570 includes a sample output structure 580 to be followed by the language model 124 or neural network model 126 when providing the response 590. The response 590 may be provided to the dialog bubble generator 310, for example, to generate suitable dialog bubbles according to a segment (e.g., identified by the topic) and the user (e.g., identified by the speaker).

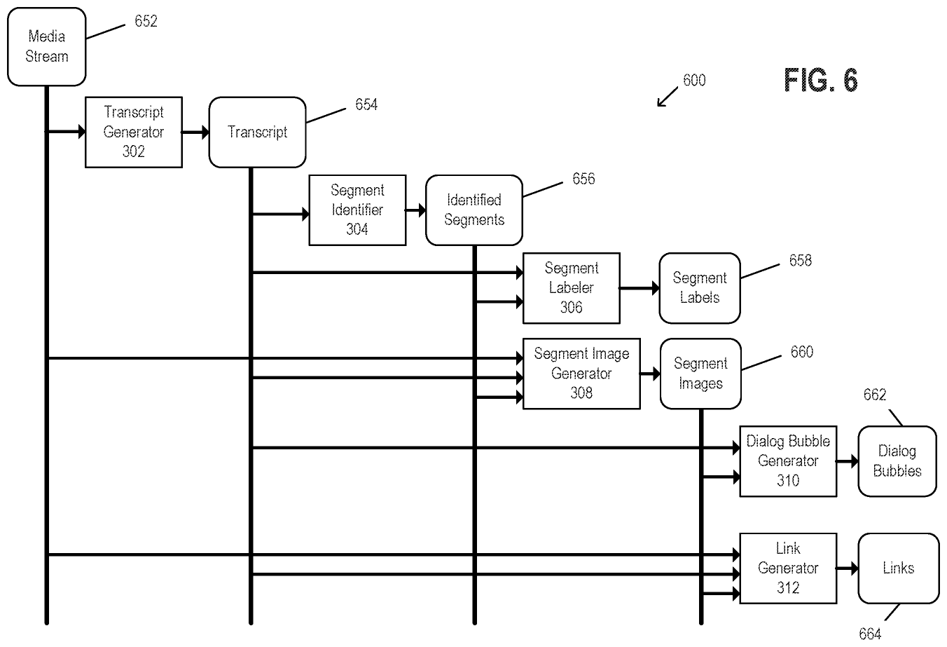

FIG. 6 shows a diagram of another example block diagram for a media stream processor 600, according to an aspect. The media stream processor 600 may generally correspond to the media stream processor 300 with similarly labeled components. In the example shown in FIG. 6, the transcript generator 302 generates a transcript 654 based on a media stream 652. The transcript 654 may generally correspond to the transcript 200, for example. The segment identifier 304 identifies segments within the transcript 654, shown as identified segments 656. In various examples, segments may be identified using only a starting timestamp, a starting timestamp and ending timestamp, or a starting timestamp and a segment duration.

The segment labeler 306 generates segment labels 658 based on the identified segments 656 and the transcript 654. The segment labels 658 may correspond to segment labels 262, 272, and 282, for example. The segment image generator 308 generates segment images 660 based on the media stream 652, the transcript 654, and the identified segments 656. The segment images 660 may correspond to segment images 260, 270, and 280, for example. The dialog bubble generator 310 generates dialog bubbles 662 based on the transcript 654 and the segment images 660. The dialog bubbles 662 may correspond to dialog bubble 264, for example. The link generator 312 generates links 664 based on the media stream 652, the transcript 654, and the segment images 660. The links 664 may correspond to the link 284, for example.

In some examples, various components within the media stream processor 600 operate in parallel to each other. For example, after the identified segments 656 are available from the segment identifier 304, the segment labeler 306 and the segment image generator 308 may operate in parallel using different threads, processors, neural network models, large language models, etc. Other possible parallel operations will be apparent to those skilled in the art.

In some examples, the media stream processor 600 is implemented as a multi-modal neural network model. For example, the media stream processor 600 may be configured to receive the media stream as an input and provide both images and text as outputs for the story board. In another example, the media stream processor 600 may receive avatar images of participants, a transcript, and the media stream as inputs and provide a suitable story board as an output.

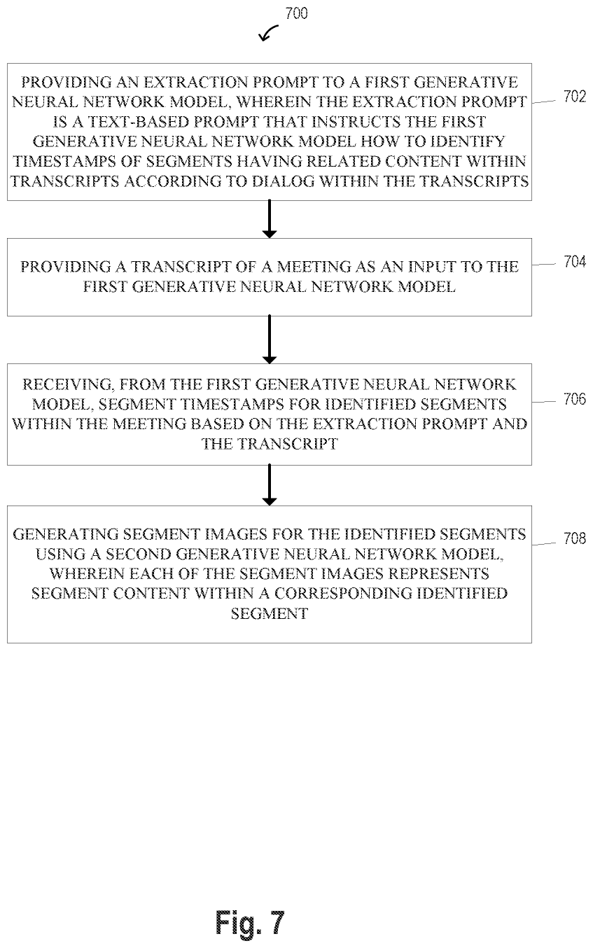

FIG. 7 shows a flowchart of an example method 700 for generating a story board, according to an aspect. Technical processes shown in these figures will be performed automatically unless otherwise indicated. In any given example, some steps of a process may be repeated, perhaps with different parameters or data to operate on. Steps in an example may also be performed in a different order than the top-to-bottom order that is laid out in FIG. 7. Steps may be performed serially, in a partially overlapping manner, or fully in parallel. Thus, the order in which steps of method 700 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. At least some steps of FIG. 7 may be performed by the computing device 120 (e.g., via the media stream processor 122), the media stream processor 300, the media stream processor 600, or other suitable computing device.

Method 700 begins with step 702. At step 702, an extraction prompt is provided to a first generative neural network model. The first generative neural network model may correspond to the language model 124 or the neural network model 126, in various examples. For example, the first generative neural network model may be a generative large language model, such as GPT, BLOOM, etc. as described above. The extraction prompt is a text-based prompt that instructs the first generative neural network model how to identify timestamps of segments having related content within transcripts according to dialog within the transcripts. For example, the extraction prompt may correspond to the prompt 454 or 470 and be provided to the language model 124 by the media stream processor 400.

At step 704, a transcript of a meeting is provided as an input to the first generative neural network model. For example, the transcript 200, the transcript 452, or the transcript 654 may be provided to the first generative neural network model (e.g., by the media stream processor 400 to the language model 124). In some examples, step 704 includes providing the extraction prompt to a large language model. In some examples, the transcript of the meeting is extracted from a media stream of the meeting that comprises audio and video (e.g., by the transcript generator 302).

At step 706, segment timestamps are received, from the first generative neural network model, for identified segments within the meeting based on the extraction prompt and the transcript. The segment timestamps may correspond to the identified segments 656 or the text summary 456, for example.

At step 708, segment images are generated for the identified segments using a second generative neural network model, where each of the segment images represents segment content within a corresponding identified segment. In some examples, step 708 includes generating, within a segment image for an identified segment, an avatar for a source user of dialog within the identified segment. The second generative neural network model may be trained to generate images from text. For example, the second generative neural network may correspond to the neural network model 126, implemented as a diffusion model, generative adversarial network, neural style transfer model, or other suitable generative neural network model. The segment images may correspond to the segment images 260, 270, and 280, for example.

The method 700 may further comprise augmenting the segment image for the identified segment with text from the dialog within the identified segment. In some examples, the text from the dialog within the identified segment is depicted within a dialog bubble for the avatar. For example, augmentation may include adding the dialog bubble 264 to the segment image 260. The avatar may be a captured image portion from a media stream of the meeting or may be generated based on a likeness of the source user, in various examples.

The method 700 may further comprise generating a link for playback of a media stream of the meeting at a timestamp corresponding to the text from the dialog within the identified segment and augmenting the segment image to include the link.

The extraction prompt may further instruct the first generative neural network model how to identify segment labels according to content within identified segments. The method 700 may further include receiving, from the first generative neural network model, segment labels for the identified segments based on the extraction prompt and the transcript, and labeling the segment images with a corresponding segment label.

In some examples, the first generative neural network model is a multi-modal neural network model and generating the segment images comprises: providing at least a portion of a media stream to the multi-modal neural network model: generating, by the multi-modal neural network model, the segment images; and receiving the segment images from the multi-modal neural network model. In one such example, the method 800 further comprises generating, by the multi-modal neural network model and within a segment image, a link to a timestamp within the media stream that corresponds to the segment image.

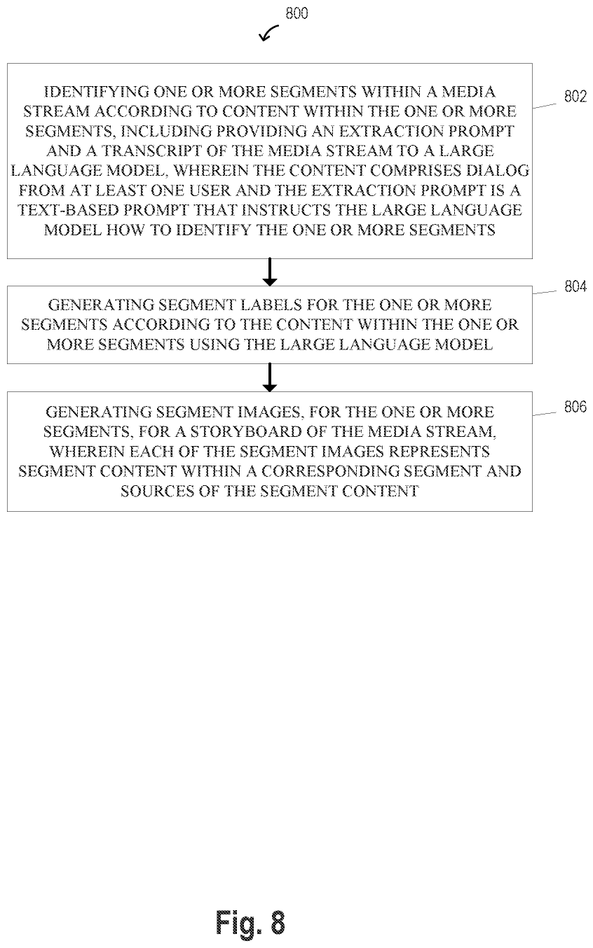

FIG. 8 shows a flowchart of an example method 800 for generating a story board, according to an aspect. Technical processes shown in these figures will be performed automatically unless otherwise indicated. In any given example, some steps of a process may be repeated, perhaps with different parameters or data to operate on. Steps in an example may also be performed in a different order than the top-to-bottom order that is laid out in FIG. 8. Steps may be performed serially, in a partially overlapping manner, or fully in parallel. Thus, the order in which steps of method 800 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. At least some steps of FIG. 8 may be performed by the computing device 120 (e.g., via the media stream processor 122), the media stream processor 300, the media stream processor 600, or other suitable computing device.

Method 800 begins with step 802. At step 802, one or more segments within a media stream are identified according to content within the one or more segments. Step 802 may include providing an extraction prompt and a transcript of the media stream to a large language model, where the content comprises dialog from at least one user and the extraction prompt is a text-based prompt that instructs the large language model how to identify the one or more segments. For example, the identified segments 656 may be identified by the segment identifier 304 from the media stream 652 (e.g., via the transcript 654). The media stream may be for a video conference, conference call (audio only), webinar, or other suitable meeting, as described above.

At step 804, segment labels are generated for the one or more segments according to the content within the one or more segments using the large language model. For example, the segment labeler 306 may generate the segment labels 658 using the language model 124.

At step 806, segment images are generated, for the one or more segments, for a story board of the media stream, where each of the segment images represents segment content within a corresponding segment and sources of the segment content. For example, the segment image generator 308 may generate the segment images 660. Step 806 may include extracting images of a source user of the at least one user from the media stream. In another example, step 806 includes generating an avatar of a source user of the at least one user using a generative neural network model.

In some examples, the method 800 further includes augmenting a segment image with text from dialog within the corresponding segment.

In some examples, the method 800 further comprises combining the segment images into the story board of the media stream, including labeling the segment images with a corresponding segment label. For example, the media stream processor 122 may combine the segment images 260, 270, and 280 into the story board 250.

In some examples, the method 800 further comprises augmenting a segment image for an identified segment with text that represents segment content within the identified segment. The text may represent dialog from a source user of the one or more users. Moreover, the segment image may comprise a visual representation of the source user and the text may be depicted within a dialog bubble for the visual representation. For example, the media stream processor 300 may generate the segment image 260 to include, or be augmented to include, the text within the dialog bubble 264, as described above. The visual representation may be a captured image portion from the media stream, an avatar generated based on the source user, or other suitable representation. In other examples, the method 800 further comprises augmenting an image (e.g., an extracted image) with a visual filter, cropping, color correction, style application, or other suitable processing.

The method 800 may further comprise generating a link to a timestamp within the media stream for the text that represents the segment content. For example, the link generator 312 may generate a link to a start of a segment or to a start of a dialog from a source user. The method 800 may further comprise generating links to timestamps within the media stream for starts of the one or more segments.

In some examples, the media stream comprises a plurality of sub-streams from computing devices of the one or more users. For example, the sub-streams are from different instances of the computing device 110. In some examples, the media stream comprises audio and video. In some examples, the media stream comprises audio and shared documents.

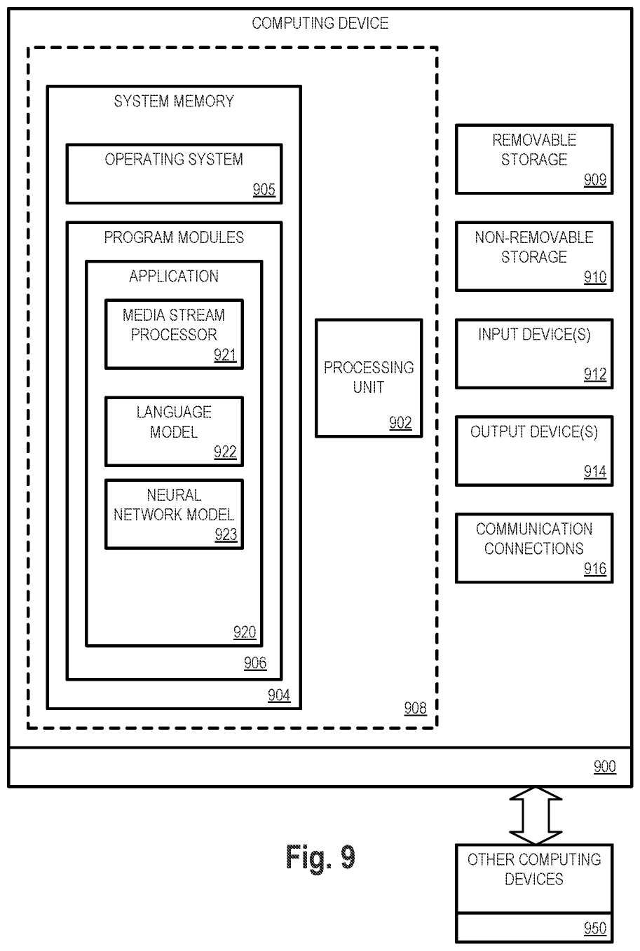

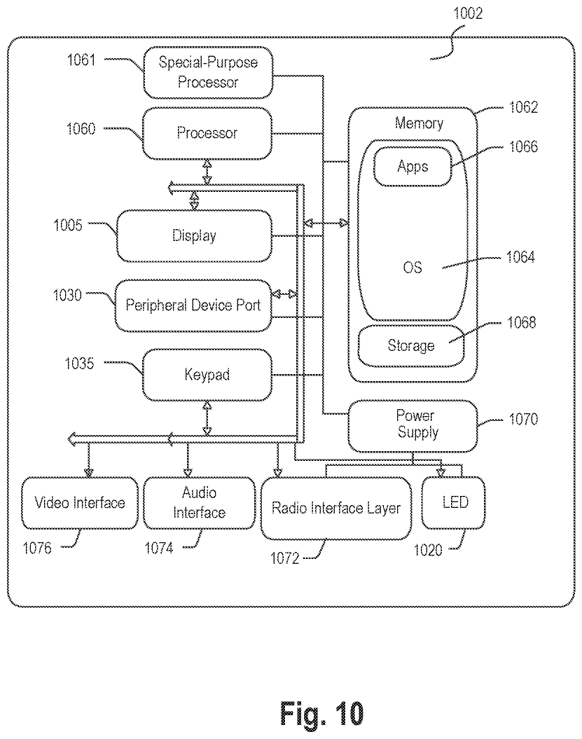

FIGS. 9 and 10 and the associated descriptions provide a discussion of a variety of operating environments in which aspects of the disclosure may be practiced. However, the devices and systems illustrated and discussed with respect to FIGS. 9 and 10 are for purposes of example and illustration and are not limiting of a vast number of computing device configurations that may be utilized for practicing aspects of the disclosure, as described herein.

FIG. 9 is a block diagram illustrating physical components (e.g., hardware) of a computing device 900 with which aspects of the disclosure may be practiced. The computing device components described below may have computer executable instructions for implementing a story board generation application 920 on a computing device (e.g., computing device 120), including computer executable instructions for story board generation application 920 that can be executed to implement the methods disclosed herein. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for running story board generation application 920, such as one or more components with regard to FIG. 1, FIG. 3, FIG. 4, FIG. 5, or FIG. 6, and, in particular, media stream processor 921 (e.g., corresponding to media stream processor 122, 300, 400, or 600), language model 922 (e.g., corresponding to language model 124), and neural network model 923 (e.g., corresponding to neural network model 126).

The operating system 905, for example, may be suitable for controlling the operation of the computing device 900. Furthermore, embodiments of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., story board generation application 920) may perform processes including, but not limited to, the aspects, as described herein. Other program modules that may be used in accordance with aspects of the present disclosure, and in particular for generating a unified graph, may include media stream processor 921.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry: universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 10 is a block diagram illustrating the architecture of one aspect of a computing device 1000. That is, the computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone. The system 1002 may include a display 1005 (analogous to display 1005), such as a touch-screen display or other suitable user interface. The system 1002 may also include an optional keypad 1035 (analogous to keypad 1035) and one or more peripheral device ports 1030, such as input and/or output ports for audio, video, control signals, or other suitable signals.

The system 1002 may include a processor 1060 coupled to memory 1062, in some examples. The system 1002 may also include a special-purpose processor 1061, such as a neural network processor. One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as email or other messages used by an email application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer.

The system 1002 has a power supply 1070, which may be implemented as one or more batteries. The power supply 1070 may further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via an audio transducer (not shown). In the illustrated embodiment, the visual indicator 1020 is a light emitting diode (LED) and the audio transducer may be a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of peripheral device port 1030 (e.g., for an on-board camera) to record still images, video stream, and the like.

A computing device 1000 implementing the system 1002 may have additional features or functionality. For example, the computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the system 1002 may be stored locally, or the data may be stored on any number of storage media that may be accessed by the device via the radio interface layer 1072 or via a wired connection between the computing device 1000 and a separate computing device associated with the computing device 1000, for example, a server computer in a distributed computing network, such as the Internet. As should be appreciated such data/information may be accessed via the computing device 1000 via the radio interface layer 1072 or via a distributed computing network. Similarly, such data/information may be readily transferred between computing devices for storage and use according to other suitable data/information transfer and storage means, including electronic mail and collaborative data/information sharing systems.

As should be appreciated, FIG. 10 is described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for generating storyboards, comprising:
providing an extraction prompt to a first generative neural network model, wherein the extraction prompt is a text-based prompt that instructs the first generative neural network model how to identify timestamps of segments having related content within transcripts according to dialog within the transcripts:
providing a transcript of a meeting as an input to the first generative neural network model:
receiving, from the first generative neural network model, segment timestamps for identified segments within the meeting based on the extraction prompt and the transcript; and
generating segment images for the identified segments using a second generative neural network model, wherein each of the segment images represents segment content within a corresponding identified segment.

2. The method of claim 1, wherein the extraction prompt further instructs the first generative neural network model how to identify segment labels according to content within identified segments, the method further comprising:
receiving, from the first generative neural network model, segment labels for the identified segments based on the extraction prompt and the transcript; and
labeling the segment images with a corresponding segment label.

3. The method of claim 1, wherein generating the segment images comprises generating, within a segment image for an identified segment, an avatar for a source user of dialog within the identified segment.

4. The method of claim 3, further comprising augmenting the segment image for the identified segment with text from the dialog within the identified segment.

5. The method of claim 4, wherein the text from the dialog within the identified segment is depicted within a dialog bubble for the avatar.

6. The method of claim 5, wherein the avatar is a captured image portion from a media stream of the meeting.

7. The method of claim 5, wherein the avatar is generated based on a likeness of the source user.

8. The method of claim 4, further comprising:
generating a link for playback of a media stream of the meeting at a timestamp corresponding to the text from the dialog within the identified segment; and
augmenting the segment image to include the link.

9. The method of claim 1, wherein the second generative neural network model is trained to generate images from text.

10. The method of claim 1, wherein the first generative neural network model is a generative large language model.

11. The method of claim 1, wherein the transcript of the meeting is extracted from a media stream of the meeting that comprises audio and video.

12. A system for generating storyboards, the system comprising:
at least one processor, and
at least one memory storing computer-executable instructions that when executed by the at least one processor cause the at least one processor to:
provide an extraction prompt to a first generative neural network model, wherein the extraction prompt is a text-based prompt that instructs the first generative neural network model how to identify timestamps of segments having related content within transcripts according to dialog within the transcripts;
provide a transcript of a meeting as an input to the first generative neural network model;
receive, from the first generative neural network model, segment timestamps for identified segments within the meeting based on the extraction prompt and the transcript;
generate segment images for the identified segments using a second generative neural network model, wherein each of the segment images represents segment content within a corresponding identified segment.

13. The system of claim 12, wherein the extraction prompt further instructs the first generative neural network model how to identify segment labels according to content within the identified segments, wherein the computer-executable instructions cause the at least one processor to:
receive, from the first generative neural network model, segment labels for the identified segments based on the extraction prompt and the transcript; and
label the segment images with a corresponding segment label.

14. The system of claim 12, wherein the computer-executable instructions cause the at least one processor to generate, within a segment image for an identified segment, an avatar for a source user of dialog within the identified segment.

15. The system of claim 14, wherein the computer-executable instructions cause the at least one processor to augment the segment image for the identified segment with text from the dialog within the identified segment so that the text from the dialog within the identified segment is depicted within a dialog bubble for the avatar.

16. The system of claim 14, wherein the avatar is a captured image portion from a media stream of the meeting.

17. A method for generating storyboards, comprising:
identifying one or more segments within a media stream according to content within the one or more segments, including providing an extraction prompt and a transcript of the media stream to a large language model, wherein the content comprises dialog from at least one user and the extraction prompt is a text-based prompt that instructs the large language model how to identify the one or more segments;
generating segment labels for the one or more segments according to the content within the one or more segments using the large language model; and
generating segment images, for the one or more segments, for a storyboard of the media stream, wherein each of the segment images represents segment content within a corresponding segment and sources of the segment content.

18. The method of claim 17, wherein generating the segment images comprises extracting images of a source user of the at least one user from the media stream.

19. The method of claim 17, wherein generating the segment images comprises generating an avatar of a source user of the at least one user using a generative neural network model.

20. The method of claim 17, further comprising augmenting a segment image with text from dialog within the corresponding segment.
